(19) United States
(12) Patent Application Publication
(10) Pub. No.: US 2026/0319340 A1
(43) Pub. Date: Oct. 15, 2026

(54) Optical Adapter Coupling System

(71) Applicant: Beastgrip, Co., Des Plaines, IL (US)

(72) Inventor: Vadym Chalenko, Fox River Grove, IL (US)

(21) Appl. No.: 19/456,758

(22) Filed: Jan. 22, 2026

Related U.S. Application Data
(60) Provisional application No. 63/788,471, filed on Apr. 14, 2025.

(51) Int. Cl. G03B 17/14

(52) U.S. Cl. CPC G03B 17/14

(57) ABSTRACT

The optical adapter coupling system is intended to provide users with an adapter device for facilitating optical coupling to an external camera system. To accomplish this, the system comprises a lens mount component that may be configured to hold a lens. Further, the lens may be configured to direct a light received from an environment towards an optical adapter device. The optical adapter device may be configured for relaying the light from the lens to at least one of an external sensor and an external lens within an external device. Furthermore, the relaying facilitates modifying a light characteristic based on an external sensor characteristic. Additionally, the system includes an external device mount that enables users to connect the optical adapter through various mounting techniques.

The current application claims a priority to the U.S. Provisional Patent application Ser. No. 63/788,471 filed on Apr. 14, 2025.

### FIELD OF THE INVENTION

The present disclosure generally relates to the field of photography and optical equipment. More specifically, the present disclosure relates to adapter devices for facilitating an optical coupling to an external camera system.

### BACKGROUND OF THE INVENTION

Smartphone cameras have advanced significantly but still lack the optical versatility of professional interchangeable lens systems. Conversion lenses, such as wide-angle, telephoto, anamorphic, and macro attachments, enhance a smartphone's field of view but cannot replicate the optical characteristics of dedicated camera lenses, particularly in achieving true zoom or shallow depth of field.

Therefore, there is a need for adapter devices for facilitating an optical coupling to an external camera system that may overcome one or more of the above-mentioned problems and/or limitations.

### SUMMARY OF THE INVENTION

The present invention is intended to provide users with an adapter device for facilitating optical coupling to an external camera system. To accomplish this, the present invention comprises a lens mount component that may be configured to hold a lens. Further, the lens may be configured to direct a light received from an environment towards an optical adapter device. The optical adapter device may be configured for relaying the light from the lens to at least one of an external sensor and an external lens comprised in an external device. To that end, the present invention comprises an external device interface that can mount the external device. Furthermore, the relaying facilitates modifying a light characteristic based on an external sensor characteristic. Additionally, the light and external sensor may be characterized by the light characteristic and the external sensor characteristic respectively.

### BRIEF DESCRIPTION OF THE DRAWINGS

FIG. 1 illustrates a schematic representation, according to a preferred embodiment of the present invention.

FIG. 2 illustrates a side elevational view of the present invention, wherein an interchangeable camera lens is mounted onto a lens mount interface.

FIG. 3 illustrates a cross-sectional view of the adapter device for facilitating an optical coupling to an external camera system, in accordance with some embodiments.

FIG. 4 illustrates a schematic representation of optical coupling, according to the present invention.

FIG. 5 illustrates a schematic representation of a plurality of optical components within the optical adapter system, according to the present invention.

FIG. 6 illustrates a second body end of the external device interface, that facilitates a threaded mount, according to a first embodiment of the present invention.

FIG. 7 illustrates a second body end of the external device interface, that facilitates a bayonet mount, according to a second embodiment of the present invention.

FIG. 8 illustrates a second body end of the external device interface, that facilitates an integrated housing, according to a third embodiment of the present invention.

### DETAILED DESCRIPTION OF THE INVENTION

All illustrations of the drawings are for the purpose of describing selected versions of the present invention and are not intended to limit the scope of the present invention.

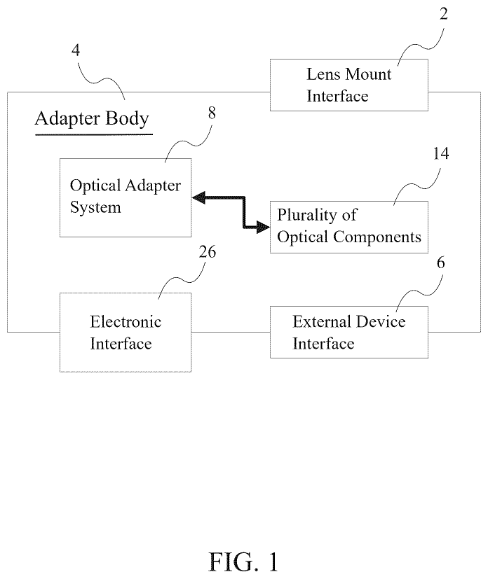

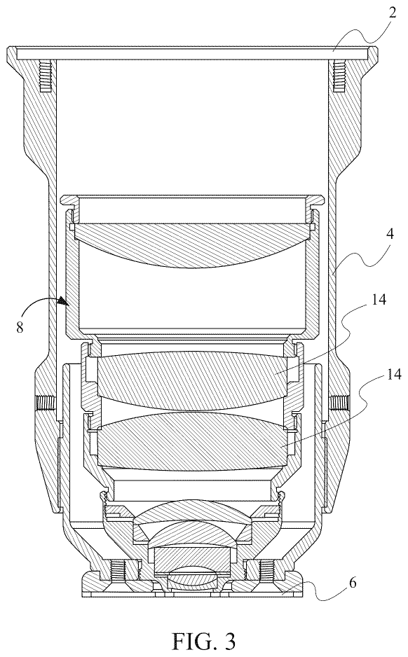

In reference to FIG. 1 through FIG. 8, the present invention is an optical relay adapter for coupling interchangeable camera lenses to a smartphone camera system. The present invention provides an optical relay system, allowing full-frame or cropped sensor camera lenses to be used with smartphones while preserving image fidelity, maintaining the correct field of view, or intentionally enabling optical magnification.

According to a preferred embodiment, the present invention comprises a lens mount interface 2, an adapter body 4, an external device interface 6, and an optical adapter system 8. The lens mount interface 2 helps with attaching an interchangeable full-frame or cropped-sensor lens. In other words, the lens mount interface 2 is configured to attach an interchangeable camera lens. The lens mount interface 2 may be compatible for attaching any lens, examples of which include, but are not limited to Canon EF, Sony E, Nikon F, PL, etc. In some embodiments, the lens mount interface 2 may be configured to hold two or more lens. Further, the two or more lenses may be characterized by two or more lens characteristics.

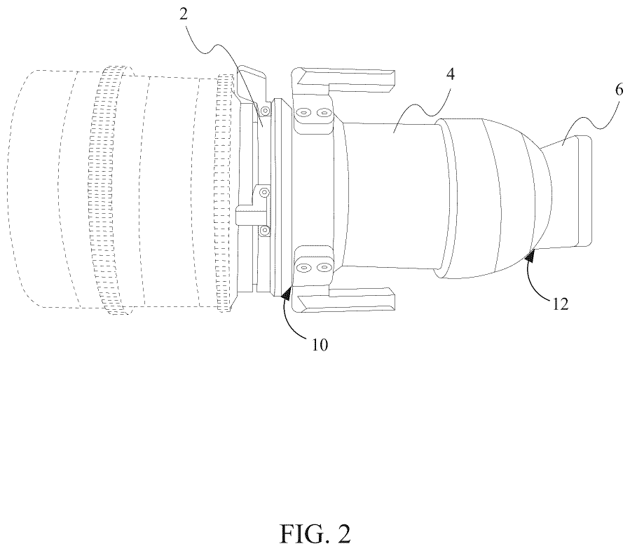

The adapter body 4 is the housing unit that houses the optical adapter system 8 or the optical relay system. In other words, the optical adapter system 8 is mounted within the adapter body 4. In the preferred embodiment, the adapter body 4 is cylindrical in shape, and the adapter body 4 comprises a first body end 10, and a second body end 12. Preferably, the first body end 10 is positioned opposite to the second body end 12 about the adapter body 4. More specifically, the first body end 10 constitutes a front end of the adapter body 4 and the second body end 12 constitutes a rear end of the adapter body 4. As seen in FIG. 2, the adapter body 4 is connected between the lens mount interface 2 and the external device interface 6. More specifically, the lens mount interface 2 is mounted adjacent to the first body end 10, and the external device interface 6 is mounted adjacent to the second body end 12.

In the preferred embodiment, the external device interface 6 is a device that helps with connecting the present invention to an external device. Preferably, the external device is a smartphone. However, the external device may be any device or system that has a processing device which may be configured for generating an image data based on the detecting an image by an external sensor lens.

According to the preferred embodiment, the optical adapter system 8 helps with one or more of the functions described below:
preserve the approximate field of view of the attached camera lens, accommodating variations in smartphone camera focal lengths or
apply an optical magnification factor to provide 1.5×, 2×, 3×, or greater optical zoom; or
modify the projected image for a specific optical effect while maintaining compatibility with smartphone camera optics;

To accomplish this, the optical adapter system 8 comprises at least one optical component 14, wherein the at least one optical component 14 is mounted between the lens mount interface 2 and the external device interface 6.

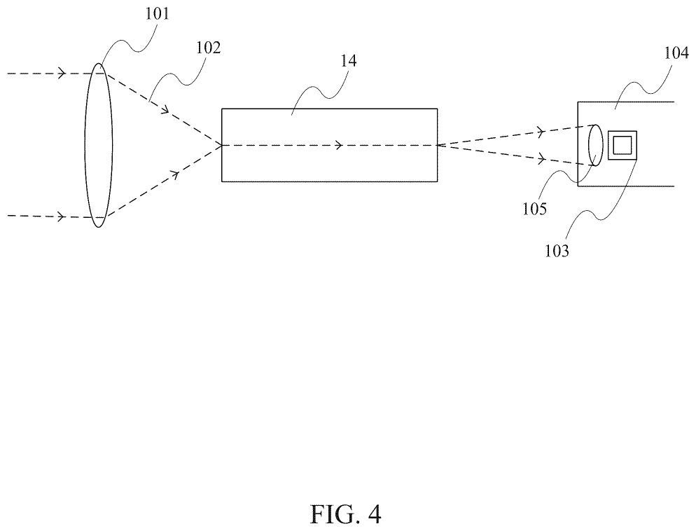

In one embodiment, and in reference to FIG. 4, the lens mount interface 2 is attached to a lens device that holds a lens 101. Further, the lens 101 may be configured to direct a light 102 received from an environment towards the optical adapter system 8. Further, the optical adapter system 8 includes at least one optical component 14 which may be configured for relaying the light 102 from the lens 101 to at least one of an external sensor 103 and an external lens 105 comprised in an external device 104. Further, the relaying facilitates modifying a light characteristic based on an external sensor characteristic. Further, the light 102 and external sensor 103 may be characterized by the light characteristic and the external sensor characteristic respectively. In some embodiments, the lens 101 includes one or more of a full frame lens and a cropped lens.

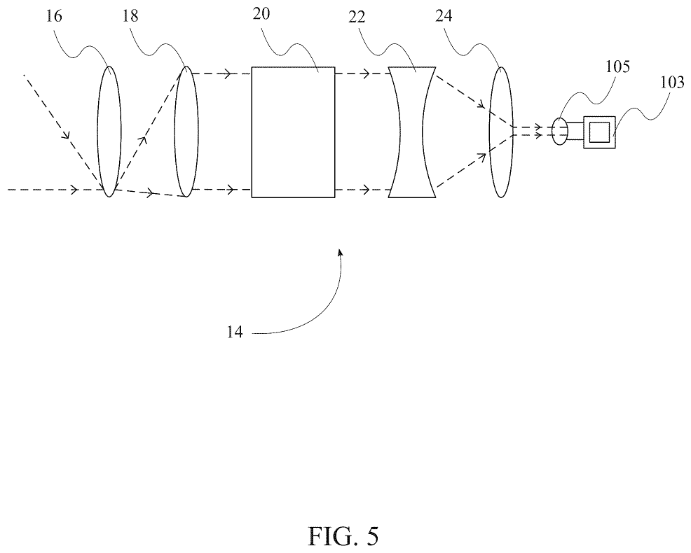

In another embodiment and in reference to FIG. 5, the at least one optical component 14 comprises an input lens 16, a relay lens 18, a beam reducer 20, a beam expander 22, and an output lens 24. Preferably, the input lens 16, the relay lens 18, the beam reducer 20, the beam expander 22 and the output lens 24 are mounted colinear within the adapter body 4. The optical adapter system 8 or the optical relay system on FIG. 5 ensures that light from an interchangeable camera lens is efficiently transmitted through the relay system and the smartphone's built-in lens onto its sensor while maintaining high image quality and optical performance. Further, the relaying facilitates modifying a light characteristic based on an external sensor characteristic. However, it should be noted that the at least one optical component 14 may include any other single of combination of optical components, such as a convex lens, a concave lens, an achromatic lens, an aspheric lens, a prism, a mirror, a fiber optic component, etc. Further, the prism may include one or more of a right-angle prism, a penta-prism and a dove prism. Furthermore, the mirror may include one or more of a flat mirror, a concave mirror and a convex mirror. Additionally, the fiber optic component may include an optical fiber.

In another embodiment, the at least one optical component 14 includes adjustable optics for optical zoom and/or chief ray angle (CRA) correction. This will help reduce or eliminate vignetting when adapting different lenses to smartphone sensors.

Continuing with the preferred embodiment, and as seen in FIG. 1, the optical adapter system 8 may comprise an electronic interface 26 for transmitting aperture, focus, or metadata information between the interchangeable camera lens and the smartphone camera system via additional equipment integration. To that end, the electronic interface 26 is mounted between the lens mount interface 2 and external device interface 6. More specifically, the electronic interface 26 is configured for transmitting aperture, focus, or metadata information between an interchangeable camera lens connected to the lens mount interface 2 and a smartphone camera system connected to the external device interface, via additional equipment integration.

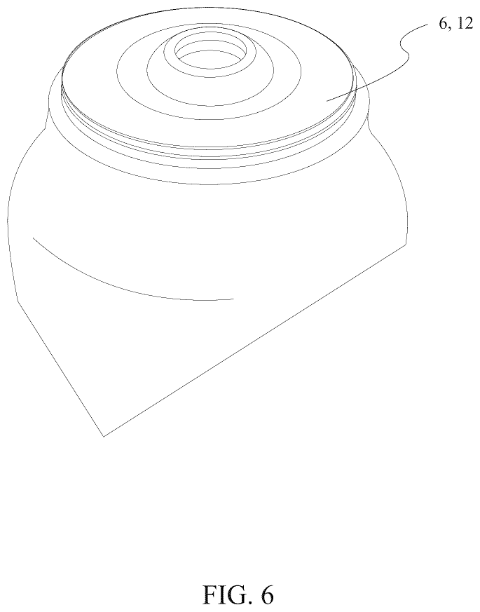

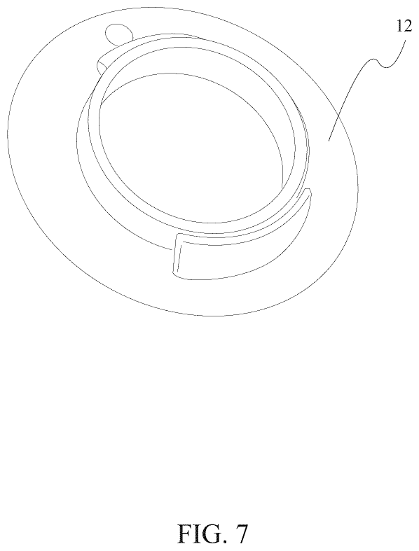

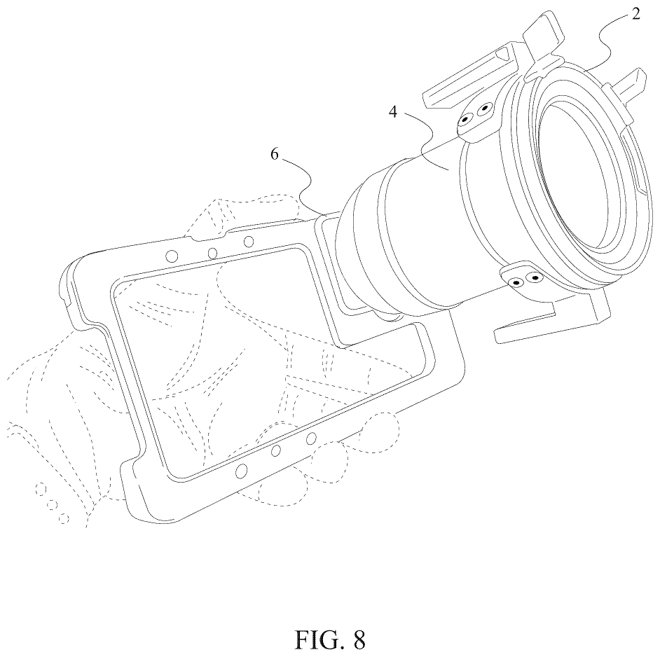

It is an aim of the present invention to enable different ways of connecting and external device to the adapter body. To that end, the external device interface 6 is a mechanical connector. As seen in FIG. 6, the second body end 12 of the body part facilitates a threaded mount, in accordance with a first embodiment. In other words, the second body end 12 includes a threaded surface configured for mounting the external device based on a thread. In reference to FIG. 7, and according to a second embodiment, the second body end 12 facilitates a bayonet mount, such that a bayonet connector may be used to connect the external device. According to a third embodiment, and in reference to FIG. 8, the external device interface 6 is an integrated housing that is configured to fully enclose a smartphone. For example, the second body end 12 may be configured to attach with an external covering of the external device. Further, the external covering includes one or more of a smartphone case, a smartphone covering and a smartphone rig.

In yet another embodiment, the external device interface 6 may be a clamping mechanism. It should be noted that the mechanical connector, the integrated housing, and the clamping mechanism may comprise any other size, shape, components, arrangement of components, etc. that are known to one of ordinary skill in the art, as long as the intents of the present invention are not altered.

With respect to optical relay options, the optical adapter system 8 of the present invention may be adapted to match different requirements.

In one embodiment, the optical adapter system 8 is configured to preserve the intended look and field of view of a camera lens mounted on the lens mount interface. In another embodiment, the optical adapter system 8 is configured to intentionally modify the intended look and field of view of a camera lens mounted on the lens mount interface. In yet another embodiment, the optical adapter system 8 is configured to explicitly cover full-frame lenses, cropped-sensor lenses, and large-format lenses, wherein the relay is adapted as needed for each format. In another scenario where the external devices have multiple cameras or multiple camera modules, the optical adapter system 8 is configured to align with one camera module at a time.

Thus, the present invention is a versatile and modular optical adapter coupling system.

Although the invention has been explained in relation to its preferred embodiment, it is to be understood that many other possible modifications and variations can be made without departing from the spirit and scope of the invention as hereinafter claimed.

What is claimed is:

1. An optical adapter coupling system comprising:
a lens mount interface;
an adapter body;
an external device interface;
an optical adapter system;
the adapter body comprising a first body end, a second body end;
the first body end being positioned opposite to the second body end about the adapter body;
the adapter body being connected between the lens mount interface and the external device interface;
the optical adapter system being mounted within the adapter body;
the lens mount interface being mounted adjacent to the first body end; and
the external device interface being mounted adjacent to the second body end.

2. The optical adapter coupling system of claim 1 further comprising:
the optical adapter system comprising at least one optical component; and
the at least one optical component being mounted between the lens mount interface and the external device interface.

3. The optical adapter coupling system of claim 2 further comprising:
the at least one optical component comprising an input lens, a relay lens, a beam reducer, a beam expander, and an output lens; and
the input lens, the relay lens, the beam reducer, the beam expander and the output lens being mounted colinear within the adapter body.

4. The optical adapter coupling system of claim 2, wherein the at least one optical component includes at least one of, a convex lens, a concave lens, an achromatic lens, an aspheric lens, a prism, a mirror, and a fiber optic component.

5. The optical adapter coupling system of claim 2, wherein the at least one optical component includes adjustable optics to reduce or eliminate vignetting when adapting different lenses to smartphone sensors.

6. The optical adapter coupling system of claim 1 comprising:
an electronic interface; and
the electronic interface being mounted between the lens mount interface and external device interface.

7. The optical adapter coupling system of claim 6, wherein the electronic interface is configured for transmitting aperture, focus, or metadata information between an interchangeable camera lens and a smartphone camera system via additional equipment integration.

8. The optical adapter coupling system of claim 1, wherein the external device interface is a mechanical connector.

9. The optical adapter coupling system of claim 1, wherein the external device interface is an integrated housing that is configured to fully enclose a smartphone.

10. The optical adapter coupling system of claim 1, wherein the external device interface is a clamping mechanism.

11. The optical adapter coupling system of claim 1, wherein the lens mount interface is configured to attach an interchangeable camera lens.

12. The optical adapter coupling system of claim 1, wherein the second body end houses a threaded mount.

13. The optical adapter coupling system of claim 1, wherein the second body end houses a bayonet mount.

14. The optical adapter coupling system of claim 1, wherein the adapter body is cylindrical in shape.

15. The optical adapter coupling system of claim 1, wherein the optical adapter system is configured to preserve the intended look and field of view of a camera lens mounted on the lens mount interface.

16. The optical adapter coupling system of claim 1, wherein the optical adapter system is configured to intentionally modify the intended look and field of view of a camera lens mounted on the lens mount interface.

17. The optical adapter coupling system of claim 1, wherein the optical adapter system is configured to explicitly cover full-frame lenses, cropped-sensor lenses, and large-format lenses.

18. The optical adapter coupling system of claim 1, wherein the optical adapter system is configured to align with one camera module at a time, when the external device includes multiple camera modules.
